(19) United States
(12) Patent Application Publication
(10) Pub. No.: US 2007/0172216 A1
(43) Pub. Date: Jul. 26, 2007

(54) Computer controlled system for synchronizing photography implementation between a 3-D turntable and an image capture device with automatic image format conversion

(75) Inventor: Peng-Cheng Lai, Panchino (TW)

Correspondence Address: BIRCH STEWART KOLASCH & BIRCH, PO BOX 747, FALLS CHURCH, VA, 22040-0747, US

(73) Assignee: Ortery Technologies, Inc.

(21) Appl. No.: 11/339,690

(22) Filed: Jan. 26, 2006

(51) Int. Cl. G03B 15/00

(52) U.S. Cl. 396/5

(57) ABSTRACT

A computer controlled system for synchronizing photography implementation between a 3-D turntable and an image capture device with automatic image format conversion includes a 3-D turntable, a 3-D turntable control module, an image capture device, an image capture control module and an automatic image format conversion module. A physical object is placed on the 3-D turntable and shot by the image capture device for each increment of a given degree of rotation angle. After a full around of rotation, the images are stored into a designated image folder in the computer and then automatically transformed into displayable format by the automatic image format conversion module. With fully automatic image generation and format conversion, what the user needs to do is only to place the object on the 3-D turntable, determine the number of images to be shot for a single revolution of the 3-D turntable, and press a start button.

### BACKGROUND OF THE INVENTION

1. Field of the Invention

The present invention relates to a system for automatic 3-D image generation and automatic image format conversion, particularly to a computer controlled system for synchronizing photography implementation between a 3-D turntable and an image capture device with automatic image format conversion.

2. Description of the Related Art

Capturing the images of a physical object at different rotation angles via a manually operated 3-D turntable has existed for a long time. However, it is hard to accurately transform the created format into a clear and displayable image format. Besides, the procedures thereof are complicated and time-consuming. Recently, digital cameras have been very popular. However, computer controlled digital-camera photography is still uncommon. Those who intend to replace the manually operated 3-D turntable with an automatic one are usually unfamiliar with the synchronizing control of digital cameras. Therefore, the best performance of full automatic photography implementation between the computer controlled 3-D turntable and image capture device is still hard to achieve. The image format of the images generated by the image capture device is usually in RAW DATA, JPG, TIFF format or others. However, the images of such a format have a very big data capacity. Therefore, they would need to be opened and transformed into the images of a low-color-level image format (such as 256 colors) manually in one by one basis; then, the images of low-color-level image format are synthesized into an image format (such as GIF) capable of displaying rotating object.

If a computer can be utilized to control a 3-D turntable and an image capture device to undertake synchronizing photography with image format conversion automatically, the persons, who are not skilled in photography or image format conversion, will also be able to work out high-quality 3-D displayable images easily, and thereby, can enhance the possibility of the created 3-D images as a tool of business communication.

### SUMMARY OF THE INVENTION

One of objects of the present invention is to provide a computer controlled system for synchronizing photography implementation between a 3-D turntable and an image capture device with automatic image format conversion, wherein the procedures from image generation to image format conversion for a 3-D displayable format are all full automatically controlled by a computer.

To achieve the abovementioned objective, the present invention proposes a computer controlled system for synchronizing photography implementation between a 3-D turntable and an image capture device with automatic image format conversion, which includes: a computer, a 3-D turntable, a 3-D) turntable control module, an image capture device, an image capture control module and an automatic image format conversion module, wherein a physical object is placed on the 3-D turntable, and the image capture device shoots the object for each increment of a given degree of rotation angle; after a full around of a rotation, the image capture device completes the capturing of a plurality of images and stores those images into a computer; the automatic image format conversion module transforms those images format created by the image capture device into the images of an automatic displayable format.

### BRIEF DESCRIPTION OF THE DRAWINGS

FIG. 1 is a diagram schematically showing the system of the present invention.

FIG. 2 is a flowchart of the operational process according to the present invention.

FIG. 3 is a diagram showing the circuitry of the 3-D turntable according to the present invention.

FIG. 4 is a diagram showing a side view of the 3-D turntable according to the present invention.

FIG. 5 is a diagram showing a top view of the 3-D turntable according to the present invention.

### DETAILED DESCRIPTION OF THE INVENTION

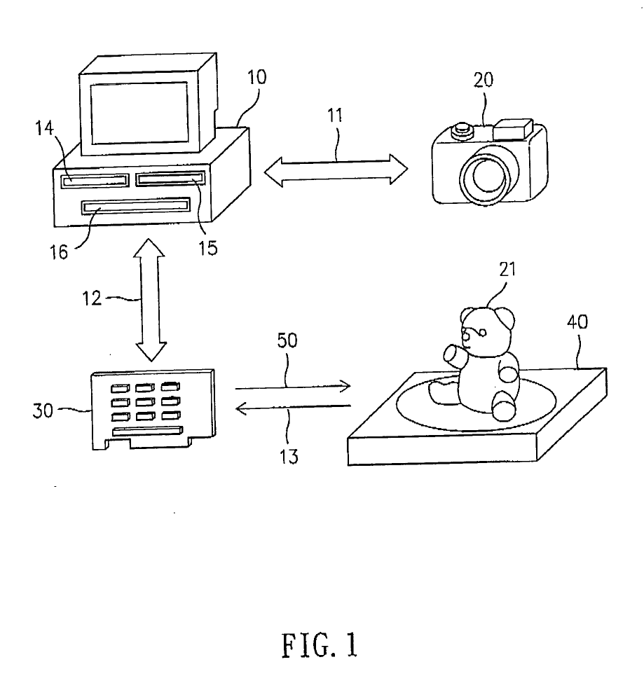

Refer to FIG. 1 a diagram schematically showing the system for automatic synchronizing photography and automatic image format conversion according to the present invention. A 3-D turntable control module 14, an image capture control module 15 and an automatic image format conversion module 16 are installed in a computer 10. The image capture control module 15 controls an image capture device 20 via a USB 11, and the 3-D turntable control module 14 controls a 3-D turntable 40 via a control card 30 and a USB 12. The control card 30 provides power for the 3-D turntable 40 via a power cable 50. When the 3-D turntable 40 rotates to a certain position, the computer 10 is informed of the message via a signal cable 13, the control card 30 and USB 12, and the computer 10 will instruct the image capture device 20 to shoot the object 21. Then, the captured images are automatically transformed into a 3-D displayable image file by the automatic image format conversion module 16.

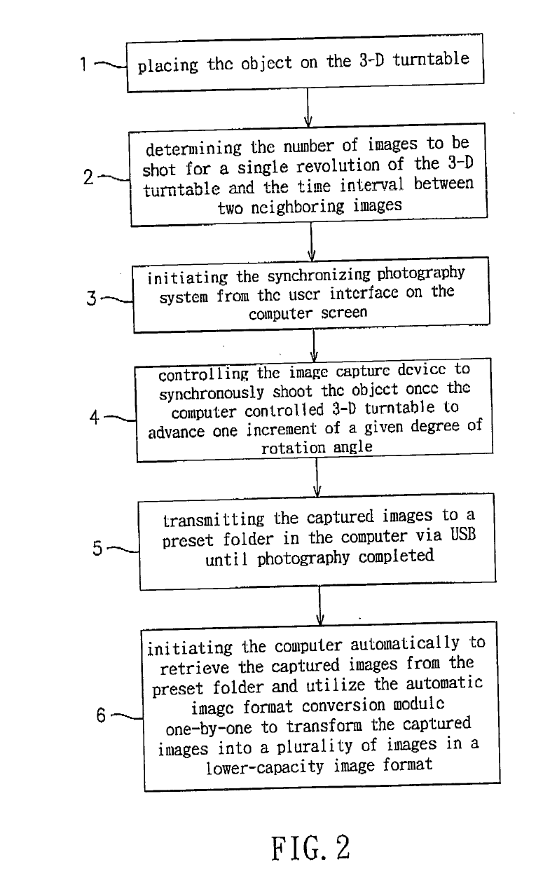

Refer to FIG. 2 a flowchart of the operational process according to the present invention. The operational process of the system of the present invention includes the following steps:

Step 1: placing the object on the 3-D turntable;

Step 2: after executing the 3-D turntable control module, image capture control module and automatic image format conversion module, and then determining the number of images to be created for a single revolution of the 3-D turntable and the time interval between two neighboring images from the user interface on the computer screen;

Step 3: initiating the synchronizing photography system by the user interface on the computer screen;

Step 4: after parameter settings are completed, starting automatic synchronizing photography, and controlling the image capture device to do synchronize object shooting once the computer controlled 3-D turntable to advance one increment of a given degree of rotation angle, until one full around of the 3-D turntable has been completed;

Step 5: after the completion of one full around of image capturing, the captured images are transferred to a preset folder in the computer via USB, and completing the image-capturing task;

Step 6: after completing the image-capturing task, initiating the computer automatically to retrieve the captured images from the preset folder and utilize the automatic image format conversion module one-by-one to transform the captured images into a plurality of images in a lower-capacity image format, which are then synthesized into a directly displayable image format capable of showing the rotation of the object.

During the abovementioned operational process, the computer automatically controls the 3-D turntable and the image capture device, and the captured images are at the output format of the image capture device. After the image capture device has completed image capturing task, the computer utilizes the automatic image format conversion module to transform the output-images format one-by-one into the images of a lower-capacity image format and integrate them into a 3-D directly displayable image format. In other words, the steps from the image generation to the integration of 3-D directly displayable image format are all automatically controlled by the computer.

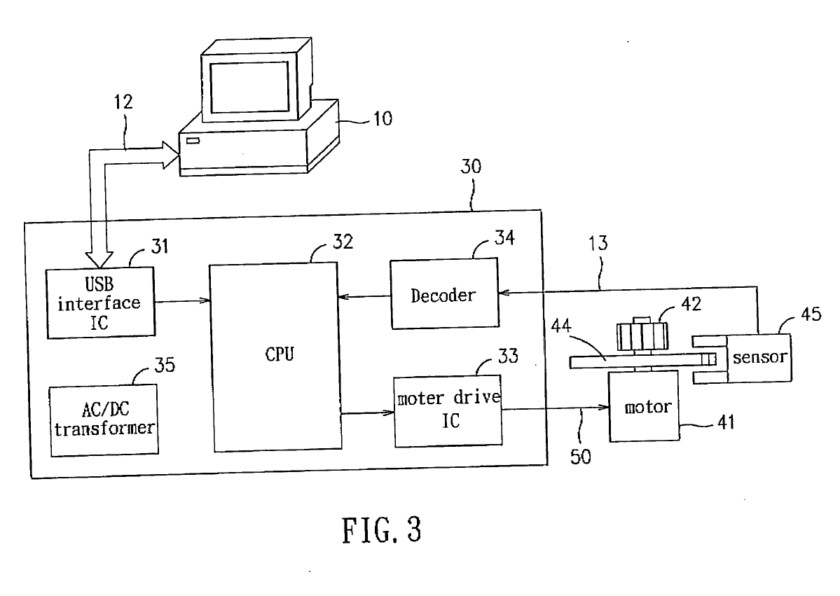

Refer to FIG. 3 a diagram schematically showing the circuitry of the 3-D turntable 40 according to the present invention for the operational process, wherein the computer 10 controls the rotation of the 3-D turntable 40 via the control card 30, and the signal is fed back to the computer 10 to enable the image capture control module 15 to control the image capture device 20 to capture images synchronously. As shown in FIG. 3, the computer 10 transmits the control commands of the 3-D turntable 40 to the CPU 32 of the control card 30 via the USB 12and a USB interface IC 31, then the control commands of the 3-D turntable 40 are converted into the applied lasting time for controlling a motor 41 via the CPU 32 and a motor drive IC 33, wherein the motor drive IC 33 of the control card 30 controls the revolution of the motor 41 via a power cable 50. The rotating motor 41 drives an optical grating 44 and a gear 42; the gear 42 drives the whole 3-D turntable 40 to rotate. The optical grating 44 is a disc-like plate having a hole; the hole will pass through a sensor 45 once for each revolution of the motor 41, and the sensor 45 can thus calculate the number of the revolution of the motor 41. The number of the revolution of the motor 41 is then transmitted to the CPU 32 via the signal cable 13 and a decoder 34 until the preset number of revolution is achieved. The AC/DC transformer 35 transforms AC into DC to provide power for the motor 41.

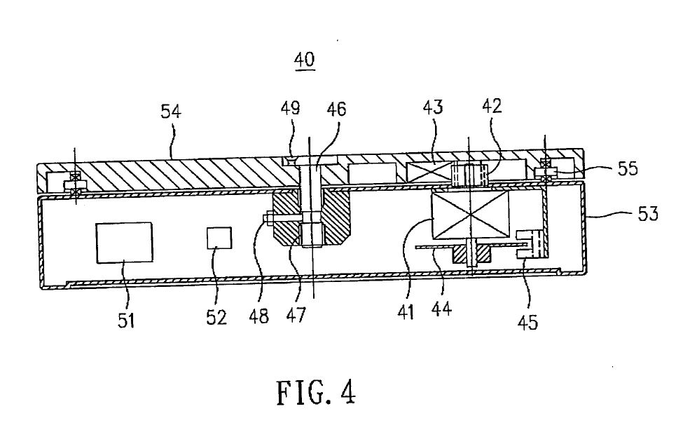

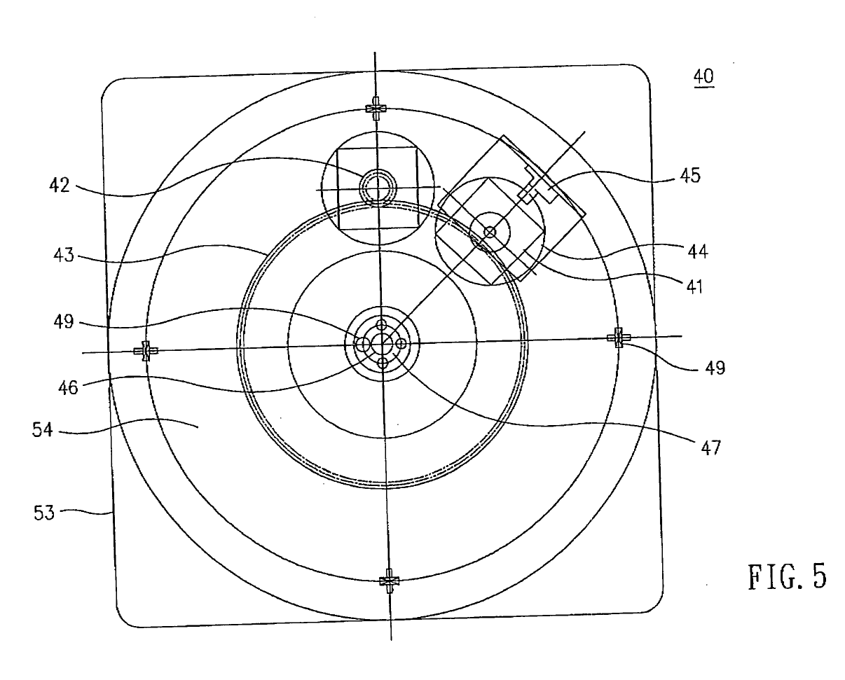

Refer to FIG. 4 and FIG. 5 diagrams respectively showing the side view and the top view of the 3-D turntable 40 according to the present invention. The 3-D turntable 40 has a base 53 and a tray 54. The base 53 covers the lower portion of the 3-D turntable 40. A plurality of rollers 55 are installed between the base 53 and the tray 54 to support the weight of the object 21 (such as shown in FIG. 1) and to enable the tray 54 to rotate smoothly. The tray 54 is fixed to a rotation shaft 46 by a fixing screw 49 and the rotation shaft 46 being the central s. The rotating motor 41 can simultaneously drive the gear 42 and the optical grating 44 to rotate. The rotating gear 42 can further drive a gear 43 to rotate. As the gear 43 is coupled to the bottom of the tray 54 of the 3-D turntable 40, the gear 43 can drive the tray 54 and the rotation shaft 46 to rotate. When the rotation shaft 46 is rotating, its lateral side will graze against an oilless bush 47, which cooperates with an set screw 48 to prevent the rotation shaft 46 from being flung out. Beside, the base 53 has a power socket 51 and a signal socket 52, which can respectively provide power and signal for the control card 30.

In summary, the present invention proposes a system for automatic 3-D photography and automatic image format conversion, wherein a computer is used to control a 3-D turntable and an image 20 capture device to automatically undertake a synchronizing photography to generate images; an automatic image format conversion module is used to transform the images into high-quality 3-D displayable images automatically. Thus, the persons, who are not skilled in photography or image format conversion, can also work out high-quality 3-D displayable images easily.

Those described above are only the preferred embodiments of the present invention, and it is not intended to limit the scope of the present invention; any equivalent modification and variation according to the spirit of the present invention is to be also included within the scope of the claims of the present invention. Thus, the present invention has been respectfully submitted above, and the approval thereof will be greatly appreciated by the inventors.

What is claimed is:

1. A computer controlled system for synchronizing photography implementation between a 3-D turntable and an image capture device with automatic image format conversion, comprising:
a 3-D turntable providing an object placing platform for rotating said object placing platform;
a 3-D turntable control module controlling the rotation of said 3-D turntable;
an image capture device shooting the object on said object placing platform according to the rotation status of said 3-D turntable to generate a plurality of images;
an image capture control module controlling the operation of said image capture device; and
an automatic image format conversion module transforming the format of the images captured by said image capture device.

2. The computer controlled system for synchronizing photography implementation between a 3-D turntable and an image capture device with automatic image format conversion according to claim 1, further comprising a computer with said 3-D turntable control module, said image capture control module, and said automatic image format conversion module being built inside said computer.

3. The computer controlled system for synchronizing photography implementation between a 3-D turntable and an image capture device with automatic image format conversion according to claim 1, wherein said 3-D turntable further comprises a control card, and said control card may be part of said 3-D turntable or an individual unit.

4. The computer controlled system for synchronizing photography implementation between a 3-D turntable and an image capture device with automatic image format conversion according to claim 1, wherein said image capture device may be any one of a digital camera, a CCD camera, and a Web Cam.

5. The computer controlled system for synchronizing photography implementation between a 3-D turntable and an image capture device with automatic image format conversion according to claim 2, wherein said computer, said 3-D turntable, and image capture device are interconnected via a plurality of signal cables.

6. The computer controlled system for synchronizing photography implementation between a 3-D turntable and an image capture device with automatic image format conversion according to claim 5, wherein said signal cables may be USB signal cables, IEEE1394 signal cables, RS232 signal cables, or other signal cables.

7. The computer controlled system for synchronizing photography implementation between a 3-D turntable and an image capture device with automatic image format conversion according to claim 2, wherein said computer controlled said 3-D turntable and said image capture device to operate synchronously to shoot the object and generate images of said object.

8. The computer controlled system for synchronizing photography implementation between a 3-D turntable and an image capture device with automatic image format conversion according to claim 1, wherein said automatic image format conversion module is used to transform the images captured by said image capture device into images of a displayable format.

9. The computer controlled system for synchronizing photography implementation between a 3-D turntable and an image capture device with automatic image format conversion according to claim 1, wherein said turntable control module, said image capture control module, and said automatic image format conversion module are integrated into a single module, or any two of them are selectively integrated into a module, or they can be an individual unit respectively.

10. The computer controlled system for synchronizing photography implementation between a 3-D turntable and an image capture device with automatic image format conversion according to claim 1, wherein after image capture is completed, a computer automatically initiates said automatic image format conversion module to undertake the conversion of image formats.

11. A 3-D turntable has at least one protrusion by the shape of post, bar or arc member positioned on the edge thereof to provide a shooting background leaning against and affixing to and prevent the shooting background from falling off when rotated.
